(19) United States
(12) Patent Application Publication
(10) Pub. No.: US 2026/0158528 A1
(43) Pub. Date: Jun. 11, 2026

(54) TANK CLEANER WITH STACK ARRANGEMENT

(71) Applicant: GEA Tuchenhagen GmbH, Buchen (DE)

(72) Inventor: Richard Collins, Cradley (GB)

(21) Appl. No.: 19/386,554

(22) Filed: Nov. 12, 2025

(30) Foreign Application Priority Data
Dec. 5, 2024 (DE) 102024136258.8

(51) Int. Cl. B08B 9/093; B05B 3/04

(52) U.S. Cl. CPC B08B 9/0936; B05B 3/0417; B08B 2209/08

(57) ABSTRACT

A tank cleaner comprising a static body having an upper housing part for coupling with a supply line and a lower housing part, a rotating body mounted on the static body, a gear arrangement with a main input shaft and a main output shaft extending beyond the housing and being configured to drive the rotating body around the main axis of rotation, and a driving arrangement coupled to the main input shaft for driving the main input shaft forced by the received cleaning fluid. The invention suggests that the gear arrangement and the driving arrangement are configured to be arranged in a stack arrangement stacked along the main axis of rotation in a predefined order and secured in a radial direction.

### CROSS-REFERENCE TO RELATED APPLICATION

This application claims priority to German Patent Application No. 102024136258.8 filed on December 5, 2024, the entire disclosure of which is incorporated herein by reference in its entirety.

### FIELD

The present invention relates to a tank cleaner, in particular orbital cleaner, for cleaning a tank. The tank cleaner comprises a static body having a housing with an upper housing part configured for coupling with a supply line for receiving a cleaning fluid and a lower housing part, a rotating body rotary about a main axis of rotation mounted on the static body, a gear arrangement comprising a gear assembly with a main input shaft and a main output shaft which extends beyond the housing and is configured to drive the rotating body around the main axis of rotation, and a driving arrangement coupled to the main input shaft for driving the main input shaft forced by the received cleaning fluid.

### BACKGROUND

In the field of tank cleaning, particularly in industrial and commercial settings, it is common to employ tank cleaners that utilize rotating nozzles to deliver high-pressure cleaning fluids. These devices are essential for maintaining hygiene and operational efficiency in tanks used for storing various substances, including food products, chemicals, and pharmaceuticals. Known systems typically involve a combination of static and rotating components, driven by fluid pressure, to achieve the desired cleaning effect, as shown in DE 10 2019 005 830 A1. The rotating nozzles are generally powered by a driving arrangement and a gear arrangement that interact to translate the fluid pressure into rotational motion.

Despite the effectiveness of these tank cleaners, several challenges persist. For instance, the assembly and maintenance of these cleaning devices can be complex and time-consuming due to the intricate arrangement of the static body which comprise gear and driving arrangements at least partly received in a housing which form the static body. According to known designs, the components are often arranged in a manner that requires precise alignment, specially adapted tools and multiple securing steps, which can lead to higher labor costs. Furthermore, the integration of the driving and gear arrangements within the housing of the cleaning device is typically not optimized for ease of assembly and maintenance. This can lead to difficulties in accessing and servicing the internal components, further complicating the maintenance process. Additionally, the correct arrangement and alignment of these components may be important for the reliable operation of the cleaning device but cannot be checked without disassembling the whole static body arrangement. Misalignment or improper securing of the gear and driving arrangements can result in mechanical failures and increased wear and tear on the components.

Despite the substantial advances in the field of tank cleaning technology, there remains a need for improved systems that address these challenges. Specifically, there is a demand for tank cleaners that offer simplified and more secure assembly and to enable checking alignment and positioning of all components.

It is therefore a technical problem underlying the present invention to provide a tank cleaning device that at least partially overcomes the disadvantages of known systems.

### SUMMARY

It is an object of this invention to provide a tank cleaner that overcomes one or more of the disadvantages of known systems.

According to a first aspect of the invention, these objects are addressed by a tank cleaner according to claim 1.

The cleaner comprises a static body with a housing that includes an upper housing part configured for coupling with a supply line to receive cleaning fluid and a lower housing part. The rotating body, which rotates about a main axis of rotation, is mounted on the static body. A gear arrangement, featuring a gear assembly with a main input shaft and a main output shaft extending beyond the housing, is configured to drive the rotating body around the main axis of rotation. The driving arrangement is operatively coupled to the main input shaft, enabling it to be driven by the received cleaning fluid. The rotating body, driven by the gear arrangement, may provide thorough and uniform cleaning coverage within the tank, addressing the challenge of reaching all internal surfaces. The gear assembly’s main input and output shafts may be precisely aligned to enable efficient power transmission, reducing wear and tear and extending the operational lifespan of the cleaner. The driving arrangement, powered by the cleaning fluid, may eliminate the need for external power sources, simplifying the cleaner’s design and operation. This configuration may also enhance the reliability of the cleaner, as it relies on the consistent flow of cleaning fluid to function. Overall, the described tank cleaner may offer a compact, efficient, and reliable solution for maintaining the cleanliness of tanks, particularly in industrial settings where thorough and consistent cleaning is essential.

The invention solves the initially mentioned object by suggesting that the gear arrangement and the driving arrangement are configured to form a stack arrangement by at least one component of the gear arrangement and a plurality of components of the driving arrangement being stacked together along the main axis of rotation in a predefined order. The components in the stack arrangement support each other in a radial direction thereby securing radial alignment of the stack arrangement. The stack arrangement enables the components to be mounted in the housing to be assembled in such a way that they are each assigned to a predefined position in the axial direction and are supported in the radial direction. The assembly can be carried out without special tools and thus simplifies the process. The components of the stack arrangement support each other and there is no need for support structures or other mounting tools. The stack arrangement thus allows removal of the drive arrangement and the gear arrangement from the housing parts of the static body without the need for specially adapted tools or destroying of any of the components thereof. However, a tool may be required for separating the two or more housing parts of the static body.

A stack arrangement in context of the present invention thus refers to an arrangement which is formed by stacking a plurality of components, in particular three or more components, onto each other along the main axis of rotation in a stacking direction, wherein each component is supported by contacting a facing surface or an edge of another component in the stack thereby enabling support in a stacking direction and defining a predefined position in the axial direction for each component of the stack arrangement. Accordingly, in order to disassemble such a stack arrangement, the components only need to be lifted from the stack against the stacking direction. Thus, the stacking direction defines the direction along the main axis of rotation of the in which the components of the gear arrangement and the drive arrangement are stacked beginning from a base of the stack arrangement to a top of the base arrangement. The support in radial direction in the stack arrangement is provided by form-fit engagement between the components of the stack arrangement realized by stacking the components in the stacking direction without any support structures outside the stack arrangement. Such a stack arrangement thus allows either one by one assembling of the components forming the stack arrangement or to selectively stack single components or pre-collected arrangements. A pre-collected arrangement may be for example a gear carrier having a number of gears mounted thereto. It shall be understood that the operational coupling of the drive arrangement and the gear arrangement is realized independently of the stacking.

In other words, the invention suggests to form a stack arrangement including the components of the gear arrangement and the driving arrangement arranged in a stack which is formed by stacking them along the main axis of rotation in a stacking direction such that the components of the gear arrangement and the driving arrangement are secured in radial direction by form-fit engagement with at least one component within the stack arrangement but remain movable against the stacking direction to allow disassemble of the stack arrangement. Thus, each component of the stack arrangement is supported in radial direction and in axial direction by one or more components of the remainder of the stack arrangement. In particular, this support prevents any radial or axial displacement of the components within the stack arrangement relative to each other. It shall be understood however, that in particular the rotating parts of the gear arrangement and the drive arrangement may be subject to minor axial or radial displacement during rotational movement due to unbalanced bearing of the respective parts. Further, additional securing mechanisms to prevent displacement of the components of the stack arrangement against the stacking direction may be used for axial securing and are within the scope of the invention.

Further embodiments of the invention are given in the dependent claims, which further develop the concept of the invention with regard to advantageous features in the context of the object of the invention and with regard to further advantages.

Preferably, the stack arrangement enables to collect the components at least in part outside the housing. In particular, stacking of parts which require special alignment that has to be verified is facilitated to be executed outside the housing, wherein other components of the stacking arrangement may be stacked inside the housing and guided into their desired position by the respective housing parts of the static body.

According to an embodiment, the stack arrangement of the tank cleaner, particularly an orbital cleaner for cleaning a tank, incorporates at least one end body designed to define a planar base area facing a remainder of the stack arrangement. During assembly, the base area is the surface onto which the stack arrangement is stacked. The end body may provide that the components of the stack arrangement are supported in the axial direction by a planar base area facing the remainder of the stack arrangement. In particular, also a surface of the end body opposite the base area is planar which enables a firm foundation on conventional surfaces, which are usually also planar. This allows the components to be aligned accurately, thereby facilitating the proper transfer of mechanical forces and rotational motion from the driving arrangement to the gear arrangement and ultimately to the rotating body. By defining a planar base area, the end body also aids in reducing the potential for misalignment or uneven wear, which can enhance the durability and operational efficiency of the tank cleaner. Furthermore, the planar base area can be orientated either upside or downside in the mounted state of the stack arrangement in the mounted tank cleaner, offering flexibility in design of the parts. In case the planar base area is orientated upside in the mounted state, the stack arrangement is stacked upside down.

According to a further embodiment, the driving arrangement comprises at least one stator and/or at least one impeller. Further preferred, the stator defines the end body which forms the planar base area. Preferably, the planar base area is orientated upside when the stack arrangement is received in the housing in the mounted state of the tank cleaner. The stator's planar upside surface facing the remainder of the stack, which forms the base area when the stack arrangement is stacked but not yet inserted in the housing, serves as a foundational element within the stack arrangement. The planar base area of the stator provides a stable and flat interface that facilitates the precise stacking of subsequent components, such as the gear arrangement, thereby enhancing the overall structural integrity and operational efficiency of the tank cleaner. By defining the base area, the stator aids in distributing the mechanical loads and stresses evenly across the stack arrangement, reducing the potential for misalignment or mechanical failure.

According to a further embodiment, the stack arrangement is axially secured by the gear arrangement. Thus, the axial positioning of the stack arrangement remains stable, thereby enhancing the overall structural integrity of the stack arrangement and the operational reliability of the tank cleaner. The axial securing mechanism provided by the gear arrangement prevents any axial displacement of the components within the stack, which could otherwise lead to misalignment or operational inefficiencies. In particular, the stack arrangement is axially secured by a plug-connection securing the gear arrangement to the drive arrangement. Further preferred, the gear assembly is in engagement with the stator by the plug-connection. This establishes a direct mechanical securement in axial direction between these two components. The interaction between the gear arrangement and the stator only contributes to the stabilization of the stack arrangement, as the stator and the gear arrangement provide two opposite supports in the axial direction providing a robust axial securing of the stack arrangement.

According to a further embodiment, the gear arrangement comprises a fixed gear being in engagement with the main output shaft. This engagement may allow the rotational motion generated by the driving arrangement, which is coupled to the main input shaft and driven by the received cleaning fluid, to be effectively transferred to the main output shaft and further to the nozzle carrier driven by the fixed gear. The engagement of the fixed gear with the main output shaft facilitates a stable and consistent transmission of torque. Furthermore, the fixed gear defines a stop shoulder for supporting the stack arrangement. This stop shoulder provides axial support to the stack arrangement, which includes the gear arrangement and the driving arrangement in a predefined order and secured in a radial direction. By defining a stop shoulder, the fixed gear may provide that the components within the stack arrangement are precisely aligned and maintained in their designated positions at the same time allowing the output shaft to extend beyond the stack arrangement to be coupled with the nozzle carrier e.g. through a recess provided in the lower housing part. By keeping the components of the stack arrangement in their designated positions, the rotational movement of the output shaft is not contravened.

According to a further embodiment, the stack arrangement comprises an enclosure part configured to receive the driving arrangement, in particular the stator and/or an impeller therein. Thus, a dedicated enclosure part within the stack arrangement for housing the driving arrangement is provided. The driving arrangement, which includes the stator and/or an impeller, is thus securely contained within this enclosure part. By housing the stator and/or impeller within the enclosure part, the design facilitates a more compact and organized assembly, reducing the risk of misalignment or mechanical interference between the components. This configuration also aids in protecting the driving arrangement from external contaminants and mechanical damage, thereby potentially increasing the longevity and reliability of the tank cleaner. Furthermore, the enclosure part can contribute to the overall structural integrity of the stack arrangement by providing additional support and rigidity. The securement in the radial direction may further provide that the components remain fixed in their designated positions, minimizing the risk of lateral displacement that could lead to operational inefficiencies or mechanical failures.

According to a further embodiment, the tank cleaner incorporates the enclosure part that includes an internal stop member. This internal stop member is specifically configured to axially support the stator and/or the impeller. By providing axial support, the internal stop member may provide that these components remain securely in place during the operation of the tank cleaner. The stator and the impeller, which interacts with the cleaning fluid to generate the necessary driving force, both benefit from this axial support. The internal stop member mitigates the risk of axial displacement or misalignment, which could otherwise lead to operational inefficiencies or mechanical failures. By axially supporting the stator and impeller within the enclosure, the design simplifies the assembly process and reduces the likelihood of assembly errors. This, in turn, contributes to the overall reliability and user-friendliness of the tank cleaner, making it a more robust and dependable solution for tank cleaning applications.

According to a further embodiment, the tank cleaner, particularly the orbital cleaner for cleaning a tank, is enhanced by incorporating an enclosure part configured as a ring gear. This ring gear is in engagement with the gear assembly and is configured to radially support the gear assembly. In particular, the enclosure part configured as a ring gear is the same enclosure part receiving the drive arrangement as described above. The ring gear meshing with the gear teeth of the gear assembly facilitates the transmission of rotational motion from the driving arrangement to the rotating body. By engaging with the gear assembly, the ring gear may permit the rotational forces to be effectively transferred and distributed, thereby enhancing the stability and efficiency of the gear operation. The radial support provided by the ring gear may maintain the alignment and integrity of the gear assembly, especially under the dynamic conditions of operation where the cleaning fluid drives the main input shaft. This radial support mitigates the potential for misalignment or displacement of the gears, which could otherwise lead to operational inefficiencies or mechanical failures. Furthermore, the configuration of the ring gear as an enclosure part adds an additional layer of protection to the gear assembly, shielding it from external contaminants and mechanical damage. Additionally, the integration of the ring gear within the stack arrangement along the main axis of rotation underscores the compact and efficient design of the tank cleaner, allowing for a streamlined assembly that is both space-saving and easy to maintain.

According to a further embodiment, the stop shoulder is a first stop shoulder. The first stop shoulder in that regards serves as an initial point of contact and support within the assembly. Furthermore, the enclosure part is designed to define a second stop shoulder, which provides an additional axial support for the stack arrangement. The second stop shoulder acts as a secondary point of stabilization. This dual-stop shoulder configuration enhances the robustness of the stack arrangement during stacking. The presence of these stop shoulders facilitates easier assembly and maintenance of the tank cleaner, as the components can be precisely positioned and locked into place without the need for complex adjustments.

According to a further embodiment, the enclosure part is configured to radially align the driving arrangement. The enclosure part may serve as a beneficial intermediary component that maintains the precise radial positioning of the driving arrangement relative to the main axis of rotation. By doing so, it facilitates a seamless and stable interaction between the driving arrangement and the gear arrangement, which are configured in a stack arrangement along the main axis of rotation. The radial alignment provided by the enclosure part mitigates any potential misalignment issues that could arise during stacking. This feature also simplifies the assembly and maintenance processes, as it provides a clear and defined structure for positioning the driving arrangement, making it easier for technicians to assemble and service the tank cleaner. Additionally, the enclosure part is preferably configured to radially align the gear arrangement. Thus, enclosure part may provide the precise radial positioning of both, the gear arrangement and the driving arrangement relative to the main axis of rotation and with each other.

According to a further embodiment, the stack arrangement includes a spacer arranged axially with respect to the main axis of rotation between the fixed gear and the enclosure part. The inclusion of the spacer serves to maintain a defined distance between the fixed gear and the enclosure part, thereby preventing any undesirable axial movement that could lead to misalignment or wear over time. This axial arrangement contributes to the stability and durability of the gear assembly by maintaining the components securely in place during assembly and operation. Furthermore, the stack arrangement is enhanced by the placement of the spacer between the first stop shoulder and the second stop shoulder. This specific positioning provides an additional layer of mechanical stability by creating a defined boundary within which the spacer operates. The first stop shoulder and the second stop shoulder act as physical barriers that limit the axial movement of the spacer, thereby keeping it in the correct position relative to the fixed gear and the enclosure part.

According to a further embodiment, the stack arrangement is configured to be inserted as a whole into either the upper housing part or the lower housing part. The stack arrangement, which comprises the gear arrangement and the driving arrangement, is designed to be pre-assembled and then inserted into the housing part as a single unit. This modular approach simplifies the installation process, as it eliminates the need for individual assembly of the gear and driving arrangements within the housing. The gear arrangement, including the gear assembly with its main input shaft and main output shaft, and the driving arrangement, which is coupled to the main input shaft, are aligned in a predefined order. This alignment may provide that the components are correctly positioned relative to each other and the main axis of rotation. The correct arrangement can be easily determined by visual inspection of the stack arrangement or parts thereof outside the housing. The stack arrangement is then inserted into the housing part, where it is secured in the radial direction. This securement prevents any lateral movement of the stack arrangement, which may maintain the components in their correct positions during operation. The new feature of being able to insert the stack arrangement as a whole reduces the time and effort required for assembly, leading to increased efficiency in the manufacturing process. Further, it simplifies maintenance and repair, as the stack arrangement can be easily removed and replaced as a single unit. This modularity allows for quicker troubleshooting and replacement of faulty components, minimizing downtime and maintenance costs.

According to a further embodiment, the driving arrangement is operatively coupled to the gear assembly by a form-fit engagement. The form-fit engagement facilitates a more straightforward and efficient assembly and disassembly process, which is particularly beneficial for maintenance and repair operations while providing a precise and robust transmission mechanism in order to transmit the rotational forces from the drive arrangement to the gear arrangement. By utilizing a form-fit, the need for complex tools and procedures to connect or disconnect the driving arrangement from the gear assembly is significantly reduced, thereby minimizing downtime and labor costs. Additionally, this type of connection may provide a secure and reliable transmission of driving force from the driving arrangement to the gear assembly, which may be beneficial for the consistent and effective operation of the rotating body around the main axis of rotation. The incorporation of a form-fit engagement also aligns with the stack arrangement of the gear arrangement and driving arrangement along the main axis of rotation, ensuring that the components are secured in an axial direction and in a radial direction. This alignment and securement contribute to the overall stability and balance of the tank cleaner.

According to a further embodiment, the tank cleaner, particularly the orbital cleaner, is enhanced by the inclusion of a housing with at least one alignment area, which is designed to have an inner diameter corresponding to an outer diameter of one or more components of the stack arrangement. This alignment area may allow precise and secure positioning of the components within the housing, thereby enhancing the overall stability and functionality of the tank cleaner. Specifically, the alignment area is configured to correspond to the outer diameter of the enclosure part and/or to the outer diameter of the spacer, and/or to the outer diameter of the fixed gear. The enclosure part, which may be an important component of the stack arrangement, may benefit from this alignment by allowing it to be securely housed, preventing any lateral movement that could disrupt the operation of the tank cleaner. Similarly, the spacer, which serves to maintain the correct distance between various components within the stack arrangement, is also securely positioned by the alignment area, which may maintain the spatial configuration of the components as designed. Furthermore, the fixed gear, which is associated to the gear arrangement, is also securely positioned by the alignment area. This parts have in common that they are not subject to any rotational movement and thus allow to enable radial alignment of the stack arrangement as a whole within the housing. In particular, the component of the stack arrangement having the outer diameter corresponding to the inner diameter of the alignment area is defined by at least one stationary member - not being involved in any rotational movement – which serves to radially align the stack arrangement in the housing.

According to a second aspect, the invention solves the initially mentioned object by a static body assembly according to claim 15. In particular, the invention suggests a static body assembly that comprises a static body with a housing that includes an upper housing part configured for coupling with a supply line to receive cleaning fluid and a lower housing part. This configuration may provide a secure and efficient connection to the fluid supply, facilitating the flow of cleaning fluid into the system. Additionally, the static body assembly incorporates a gear arrangement that includes a gear assembly with a main input shaft and a main output shaft which extends beyond the housing. The driving arrangement is coupled to the main input shaft, which is driven by the received cleaning fluid, thereby converting the fluid's kinetic energy into mechanical energy to drive the cleaning process. The gear arrangement and the driving arrangement are configured to form a stack arrangement by stacking at least one component of the drive arrangement and a plurality of components of the gear arrangement along the main axis of rotation in a predefined order. In the stack arrangement, the components support each other in a radial detection thereby securing alignment of the stack arrangement in the radial direction. By having the stack arrangement, the static body assembly participates from the benefits described with regard to the first aspect of the invention. Thus, benefits and preferred embodiments of the first aspect of the invention are at the same time benefits and preferred embodiments of the second aspect of the invention.

According to a third aspect, the invention solves the initially mentioned object by a method for mounting a tank cleaner, particularly an orbital cleaner, according toclaim 16. The method begins with providing a static body that includes a housing with an upper housing part configured for coupling with a supply line to receive a cleaning fluid and a lower housing part. This initial step establishes the foundational structure necessary for subsequent assembly. Following this, the method entails stacking a gear arrangement and a driving arrangement together to form a stack arrangement. The gear arrangement includes a gear assembly with a main input shaft and a main output shaft that extends beyond the housing and is configured to drive the rotating body around the main axis of rotation. In particular, the stack arrangement is formed by stacking components of the driving arrangement and the gear arrangement along the main axis of rotation in a predefined order in the stacking direction and thereby securing the components in a radial direction. Optionally, the method further includes axially securing of the stack arrangement, in particular by a pug-connection enabling axial securement of the drive arrangement and the gear arrangement against axial displacement relative to each other which may lead to disassembling of the stack arrangement. The driving arrangement is preferably operatively coupled to the main input shaft. This coupling is in particular realized during formation of the stack arrangement by stacking the components together, enabling the driving arrangement to drive the main input shaft when forced by the received cleaning fluid. This coupling mechanism is preferably of the form-fit type and may allow the effective transmission of the driving force from the cleaning fluid to the gear arrangement, thereby facilitating the rotation of the rotating body. The stack arrangement is meticulously stacked along the main axis of rotation in a predefined order and secured in a radial direction, which may provide that the components are aligned and stable during operation. The method further comprises inserting the stack arrangement – which is preferably secured in the axial direction - into either the upper housing part or the lower housing part, depending on the design and assembly requirements. In that regard, the gear arrangement and the drive arrangement are either inserted into one of the upper housing part and the lower housing part when already forming the stack arrangement. Alternatively, the components of the gear arrangement and the driving arrangement are individually inserted into one of the upper housing part and the lower housing part and stacked therein to form the stack arrangement. This insertion step facilitates forming a static body arrangement defining the static body having the housing with the gear arrangement and the driving arrangement received therein. Alternatively, the stack arrangement may be stacked at least party within the upper housing part or the lower housing part. Once the stack arrangement is in place, the method involves closing the upper housing part and the lower housing part, which secures the internal components and protects them from external elements. Finally, the method includes mounting a rotating body that rotates about the main axis of rotation on the static body. This final step completes the assembly, resulting in a fully functional tank cleaner capable of efficient and effective cleaning operations. By assembling a stack arrangement, the method participates from the benefits described with regard to the first aspect of the invention. Thus, benefits and preferred embodiments of the first aspect of the invention are at the same time benefits and preferred embodiments of the third aspect of the invention.

### BRIEF DESCRIPTION OF THE DRAWINGS

The present disclosure will be explained in more detail, by way of example, with reference to the drawings in which:

FIG. 1a: shows an embodiment of a tank cleaner with a static body, a rotating body, and multiple nozzles;

FIG. 1b: shows a cross-sectional view of the tank cleaner showing the internal components including the gear arrangement, driving arrangement, and housing;

FIG. 2: shows an exploded perspective view of a stack arrangement for a tank cleaner, illustrating the components including the driving arrangement, gear assembly, and enclosure part;

FIG. 3: shows an exploded side view of the components of a tank cleaner, illustrating the stack arrangement of the driving arrangement and gear arrangement along the main axis of rotation; and

FIG. 4: shows a flow chart illustrating a method for assembling a static body arrangement.

### DETAILED DESCRIPTION

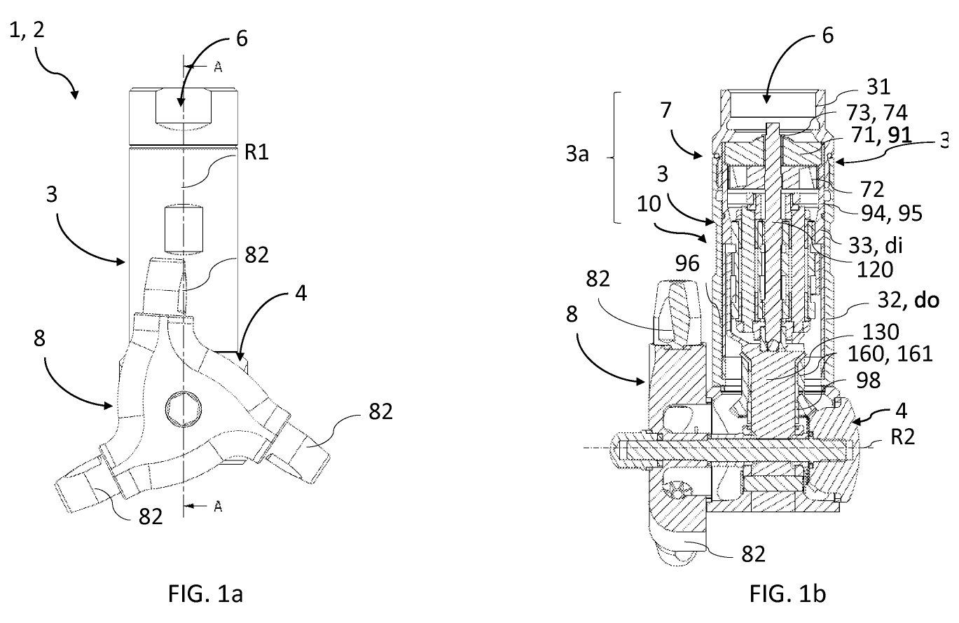

FIG. 1a illustrates a tank cleaner 1, specifically an orbital cleaner 2, designed for cleaning tanks.

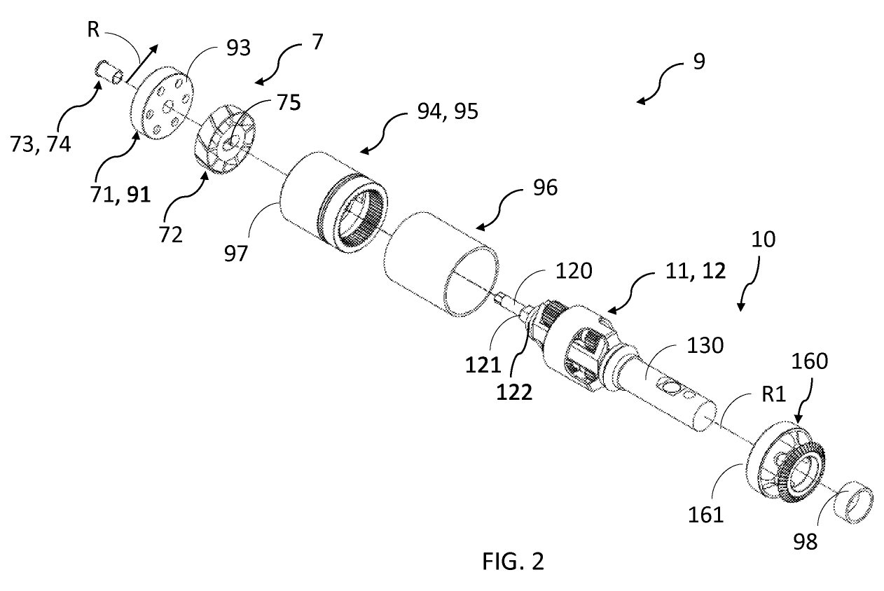

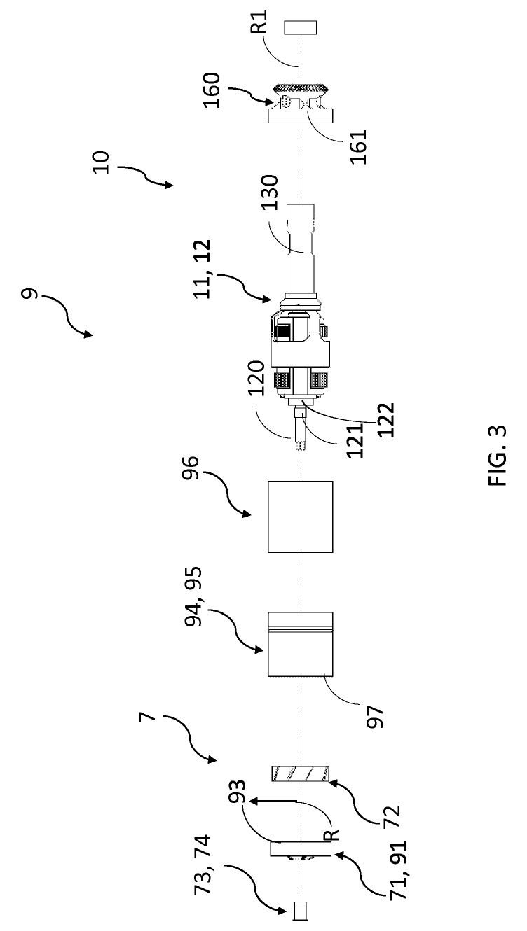

The tank cleaner 1 comprises a static body arrangement 3a, a rotating body 4 and a nozzle carrier 8. The static body arrangement 3a includes a static body 3 and a stack arrangement 9 illustrated in FIG. 2 and FIG. 3.

The static body 3 includes a housing 30 with an upper housing part 31 and a lower housing part 32. The upper housing part 31 is configured for coupling with a supply line 6 to receive cleaning fluid. The upper housing part 31 facilitates the connection to the supply line 6, which may allow the cleaning fluid to be directed into the housing 30 for subsequent use in the cleaning process.

The rotating body 4 is mounted on the static body 3 and rotates about a main axis of rotation R1.The rotating body 4 is driven by a gear arrangement 10 (see FIG. 1b) and a driving arrangement 7 (see FIG. 1b) around the main axis of rotation R1. This rotational capability allows the rotating body 4 to perform cleaning operations within the tank by distributing the cleaning fluid in a controlled manner. The rotating body 4, which is mounted on the static body 3, rotates about the main axis of rotation R1, wherein the nozzle carrier 8 is supported by the rotating body 4 rotary around a secondary axis of rotation R2.

The tank cleaner 1 also includes multiple nozzles 82 mounted on the nozzle carrier 8 which is driven around the secondary axis of rotation R2 and supported by the rotating body 4. The nozzles 82 are strategically positioned to direct the cleaning fluid within the tank, which may allow thorough cleaning.

FIG. 1b provides a cross-sectional view of the tank cleaner 1, detailing the internal components and their configuration.

The driving arrangement 7 includes a stator 71 and an impeller 72, which are preferably housed within an enclosure part 94. The stator 71 may define an end body 91 arranged on top of the stack arrangement as shown in FIG. 2.

The gear arrangement 10 comprises a gear assembly 11 configured as a planetary gear12 with a main input shaft 120 and a main output shaft 130. The gear assembly 11 is configured to drive the rotating body 4 around the main axis of rotation R1.

The driving arrangement 7 is operatively coupled to the main input shaft 120, in particular by a form-fit engagement, and is responsible for driving the main input shaft 120 using the force provided by the received cleaning fluid. This coupling allows the cleaning fluid to power the gear arrangement 10, which in turn drives the rotating body 4 thereby enabling a secure and efficient transfer of rotational force.

The driving arrangement 7 is axially secured to the gear assembly 11 via a plug-connection 73, which may provide axial securement of the stack arrangement 9.

The main output shaft 130 extends beyond the housing 30 and is configured to drive the rotating body 4 around the main axis of rotation R1. This arrangement may allow the rotational motion necessary for cleaning to be transmitted from the gear assembly 11 to the rotating body 4.

The main output shaft 130 is further in engagement with a fixed gear 160 advancing the nozzle carrier 8 to rotate about the secondary axis of rotation R2. The fixed gear 160 defines a stop shoulder 161, which supports the stack arrangement 9.

Additionally, a spacer 96 is positioned axially between the fixed gear 160 and the enclosure part 94. The enclosure part 94 is configured as a ring gear 95, which engages with the gear assembly 11 and provides radial support for both, the gear assembly 11 and the drive arrangement 7.

The housing 30 features at least one alignment area 33 with an inner diameter di corresponding to the outer diameter do of the enclosed components, such as the enclosure part 94, the spacer 96, and the fixed gear 160.

For assembly, the gear arrangement 10 and the driving arrangement 7 are designed to be arranged in a stack arrangement 9 along the main axis of rotation R1 in a predefined order which is shown in FIG. 2 and FIG. 3. This stack arrangement 9 is secured in a radial direction R, which may provide that the components remain properly aligned and function cohesively to facilitate the cleaning process within the tank.

FIG. 2 and FIG. 3 illustrate an exploded view specifically detailing the stack arrangement 9 along the main axis of rotation R1, wherein FIG. 2 shows the stack arrangement 9 in a perspective view and FIG. 3 shows the stack arrangement 9 in a side view. Identical or similar components have the same reference signs in FIG. 1a, FIG. 1b, FIG. 2 and FIG. 3 and reference is made to the above description.

The stack arrangement 9 is composed of the driving arrangement 7 and the gear arrangement 10 and preferably designed to be inserted as a whole into either the upper housing part 31 or the lower housing part 32, facilitating assembly and maintenance.

Starting from the left side of FIG. 2 and FIG. 3, the driving arrangement 7 includes the stator 71, which defines the end body 91 arranged on top of the stack arrangement 9 in the mounted state shown in FIG. 1b which forms the base area 93 of the stack arrangement 9 during assembly (see FIG. 2). As such, the stack assembly 9 is preferably stacked in an upside-down manner with respect to the mounted state shown in FIG. 1b.

The stator 71 is coupled to the main input shaft 120 by the plug 74 thereby defining the plug-connection 73, facilitating the axial securement of the drive arrangement 7 to the gear arrangement 10. Adjacent to the stator 71 is the impeller 72, which is also part of the driving arrangement 7. The impeller 72 is responsible for converting the received cleaning fluid into mechanical energy to drive the main input shaft 120. This rotational movement advancing the main input shaft 120 is transmitted via a form-fit engagement between the impeller 72 and the main input shaft 120. The impeller 72 has a recess 75 and the main input shaft 120 has a mating outer contour 121 which engages the recess 75 of the impeller 72. The impeller 72 is supported in the direction of the main axis of rotation R1 by resting with a contact surface facing toward the gear assembly 11 on a support surface 122 of the gear assembly 11 associated to the main input shaft 120.

Next in the stack arrangement 9 is the enclosure part 94, configured as a ring gear 95. The ring gear 95 engages with the gear assembly 11, providing radial support.

The gear arrangement 10 is depicted next, comprising the gear assembly 11. The gear assembly 11 includes the main input shaft 120 and the main output shaft 130. The main input shaft 120 is driven by the driving arrangement 7, while the main output shaft 130 extends beyond the housing 30 (see FIG. 1a, 1b) to drive the rotating body 4 see (FIG. 1a, 1b) around the main axis of rotation R1.

The fixed gear 160, part of the gear arrangement 10, engages with the main output shaft 130. The fixed gear 160 defines a stop shoulder 161, which supports the stack arrangement 9.

The enclosure part 94 also features an internal stop member 94a, which axially supports the stator 71 and/or the impeller 72. Additionally, the enclosure part 94 defines the second stop shoulder 97, further supporting the stack arrangement 9.

Additionally, the stack arrangement 9 includes the spacer 96, positioned axially between the fixed gear 160 and the enclosure part 94, specifically between the first stop shoulder 161 and the second stop shoulder 97 defined by the enclosure part 94. This spacer 96 may maintain proper axial alignment and spacing within the stack arrangement 9.

In summary, the stack arrangement 9 is meticulously organized along the main axis of rotation R1. The driving arrangement 7, including the stator 71 and impeller 72, initiates the mechanical movement, which is then transferred through the gear arrangement 10, comprising the gear assembly 11 with the main input shaft 120 and main output shaft 130. The enclosure part 94, configured as a ring gear 95, along with the spacer 96, may provide proper alignment and support within the stack arrangement 9. The fixed gear 160, with its stop shoulder 161, provides additional axial support, completing the assembly as depicted in FIG. 2.

The overall design of the tank cleaner 1, with its stack arrangement 9 and integrated gear arrangement 10 and driving arrangement 7, provides a robust and efficient solution for tank cleaning applications.

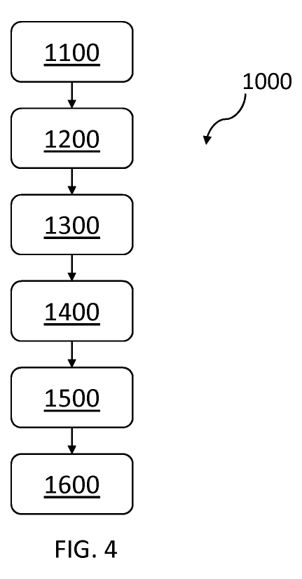

FIG. 4 depicts a flow chart of a method 1000 for mounting a tank cleaner 1, in particular a tank cleaner 1 according to FIG. 1a and FIG. 1b.

In a first step 1100 of the method 100, a static body 3 having a housing 30 with an upper housing part 31 configured for coupling with a supply line 6 for receiving a cleaning fluid and a lower housing part 32 is provided.

In a second step 1200, the method 1000 includes stacking a gear arrangement 10 and a driving arrangement 7 together to form a stack arrangement 9, in particular stacking each component of the gear arrangement 10 and the driving arrangement 7 together in one by one manner optionally including also pre-assembled components to form the stack arrangement 9.

The gear arrangement 10 is preferably designed in accordance with FIG. 2 and FIG. 3 and comprises a gear assembly 11 with a main input shaft 120 and a main output shaft 130 extending beyond the housing 30 and the driving arrangement 7 coupled to the main input shaft 120 for driving the main input shaft 120 forced by the received cleaning fluid. In the second step 1200, the stack arrangement 9 is formed by stacking the components of the driving arrangement 7 and the gear arrangement along the main axis of rotation R1 in a predefined order in the stacking direction and thereby securing the components in a radial direction R. Optionally, the method 1000 further includes axially securing of the stack arrangement 9, in particular by a pug-connection 93. The pug-connection 93 is realized between the plug 94 and the input shaft 120, wherein the plug 94 rests against a surface of the stator 71 facing away from the remainder of the stack arrangement 9. As such, the plug 94 secures the drive arrangement 7 and the gear arrangement 10 against each other in the axial direction thereby providing axial securement of the stack.

A third step 1300 of the method 1000 encompasses inserting 1300 the gear arrangement 10 and the driving arrangement 7 into one of the upper housing part 31 and the lower housing part 32. In a first alternative, the gear arrangement 10 and the driving arrangement 7 are inserted into one of the upper housing part 31 and the lower housing part 32 when already forming the stack arrangement 9. Alternatively, the gear arrangement 10 and the driving arrangement 7 are at least partly individually inserted into one of the upper housing part 31 and the lower housing part 32 and stacked therein to form the stack arrangement 9.

Next, the upper housing part 31 and the lower housing part 32 are closed in a fourth step 1400.

In a fifth step 1500, the method 1000 comprises mounting a rotating body 4 rotary about a main axis of rotation R1 on the static body 3.

Preferably, the method 1000 comprises in a sixth step 1600 mounting of a nozzle carrier 8 with one or more nozzles 82 to the rotating body 4, wherein the nozzle carrier 8 is mounted as to engage the gear arrangement 10, in particular the fixed gear 160 as to be driven around the secondary axis of rotation R2.

1. A tank cleaner for cleaning a tank, the tank cleaner comprising:
a static body having a housing with an upper housing part and a lower housing part, the upper housing part being configured for coupling with a supply line for receiving a cleaning fluid;
a rotating body mounted on the static body and rotatable about a main axis of rotation;
a gear arrangement comprising a gear assembly with a main input shaft and a main output shaft extending beyond the housing, the gear assembly being configured to drive rotation of the rotating body about the main axis of rotation; and
a driving arrangement coupled to the main input shaft, the driving arrangement being configured to drive the main input shaft via the cleaning fluid;
wherein the gear arrangement and the driving arrangement are configured to form a stack arrangement with at least one component of the gear arrangement and a plurality of components of the driving arrangement stacked along the main axis of rotation; and
wherein the components in the stack arrangement radially support each other to secure a radial alignment the stack arrangement.

2. The tank cleaner according to claim 1, wherein the stack arrangement has at least one end body configured to define a base area facing a remainder of the stack arrangement, and wherein the base area is oriented upwardly or downwardly when the stack arrangement is in a mounted state.

3. The tank cleaner according to claim 2, wherein the driving arrangement comprises at least one stator defining the at least one end body which defines the base area.

4. The tank cleaner according to claim 3, wherein the stack arrangement is axially secured by the gear arrangement via a plug-connection that secures the gear arrangement to the drive arrangement.

5. The tank cleaner according to claim 1, wherein the gear arrangement comprises a fixed gear engaged with the main output shaft, the fixed gear defining a stop shoulder for supporting the stack arrangement.

6. The tank cleaner according to claim 1, wherein the stack arrangement comprises an enclosure part configured to receive at least part of the driving arrangement.

7. The tank cleaner according claim 6, wherein the enclosure part is configured to receive at least one of a stator and an impeller of the driving arrangement therein.

8. The tank cleaner according to claim 6, wherein the enclosure part has an internal stop member configured to axially support at least one of a stator and an impeller of the driving arrangement.

9. The tank cleaner according claim 6, wherein the enclosure part is configured as a ring gear, the enclosure part engaging with the gear assembly and radially supporting the gear assembly.

10. The tank cleaner according to claim 5, wherein the enclosure part defines a second stop shoulder for supporting the stack arrangement.

11. The tank cleaner according to claim 6, wherein the enclosure part is configured to radially align the driving arrangement.

12. The tank cleaner according to claim 6, wherein the stack arrangement comprises a spacer arranged axially with respect to the main axis of rotation between the fixed gear and the enclosure part.

13. The tank cleaner according to claim 12, wherein the spacer is disposed between a first stop shoulder and a second stop shoulder.

14. The tank cleaner according to claim 1, wherein the stack arrangement is configured to be inserted as a whole into one of the upper housing part and the lower housing part.

15. The tank cleaner according to claim 1, wherein the driving arrangement is operatively coupled to the gear assembly by a form-fit engagement.

16. The tank cleaner according to claim 1, wherein the stack arrangement comprises an enclosure part, a spacer, and a fixed gear; and wherein the housing has at least one alignment area with an inner diameter corresponding to an outer diameter of at least one of the enclosure part, the spacer, and the fixed gear.

17. A static body assembly for a tank cleaner, the static body assembly comprising:
a static body having a housing with an upper housing part and a lower housing part, the upper housing part being configured for coupling with a supply line for receiving a cleaning fluid;
a gear arrangement comprising a gear assembly with a main input shaft and a main output shaft extending beyond the housing; and
a driving arrangement coupled to the main input shaft, the driving arrangement being configured to drive the main input shaft via the cleaning fluid;
wherein the gear arrangement and the driving arrangement are configured to form a stack arrangement with at least one component of the gear arrangement and a plurality of components of the driving arrangement stacked along a main axis of rotation; and
wherein the components in the stack arrangement radially support each other to secure a radial alignment of the stack arrangement.

18. A method for mounting a tank cleaner, the method comprising the steps of:
providing a static body having a housing with an upper housing part and a lower housing part, the upper housing part being configured for coupling with a supply line for receiving a cleaning fluid;
stacking a plurality of components of a gear arrangement and at least one component of a driving arrangement together to form a stack arrangement, the gear arrangement comprising a gear assembly with a main input shaft and a main output shaft extending beyond the housing and being configured to drive the rotating body around a main axis of rotation, the driving arrangement operatively being coupled to the main input shaft and configured to drive the main via the received cleaning fluid, wherein the stack arrangement is formed by stacking the components of the driving arrangement and the gear arrangement along the main axis of rotation, and wherein the components in the stack arrangement radially support each other to secure a radial alignment of the stack arrangement;
inserting the gear arrangement and the driving arrangement into one of the upper housing part and the lower housing part;
closing the upper housing part and the lower housing part; and
mounting a rotating body rotary about the main axis of rotation on the static body.

19. The method of claim 18, wherein the gear arrangement and the driving arrangement are inserted into the one of the upper housing part and the lower housing part when forming the stack arrangement.

20. The method of claim 18, wherein the gear arrangement and the driving arrangement are separately inserted into the one of upper housing part and the lower housing part and stacked therein to form the stack arrangement.
